(19) United States
(12) Patent Application Publication
(10) Pub. No.: US 2025/0333159 A1
(43) Pub. Date: Oct. 30, 2025

(54) CORRELATED MAGNET THRESHOLD CLUTCH AND METHODS THEREOF

(71) Applicant: Supernal, LLC, Washington, DC (US)

(72) Inventor: Matthew Phillip ARALIS, Redwood City, CA (US)

(73) Assignee: Supernal, LLC, Washington, DC (US)

(21) Appl. No.: 18/866,209

(22) PCT Filed: Jun. 8, 2023
(86) PCT No.: PCT/US2023/024885

§ 371 Date: Nov. 15, 2024

Related U.S. Application Data
(60) Provisional application No. 63/366,183, filed on Jun. 10, 2022.

(51) Int. Cl. B64C 11/02; B64C 29/00; B64D 35/00; H02K 49/10

(52) U.S. Cl. CPC B64C 11/02; B64D 35/00; H02K 49/108; B64C 29/0016

(57) ABSTRACT

Systems and methods for a hub system are disclosed. The hub system includes: a motor operably coupled to a first correlated magnet, wherein the first correlated magnet defines a first attachment surface having one or more first alignment configurations. The hub system may further include a propeller hub including one or more blades, wherein the propeller hub is operably coupled to a second correlated magnet, and wherein the second correlated magnet defines a second attachment surface having one or more second alignment configurations. In addition, the motor and the propeller hub may be removably coupled together via one or more of: a magnetic attraction force formed between the first attachment surface of the first correlated magnet and the second attachment surface of the second correlated magnet; and an engagement between the one or more first alignment configurations and the one or more second alignment configurations.

### CROSS REFERENCE TO RELATED APPLICATIONS

This application claims priority to U.S. Provisional Application No. 63/366,183 filed Jun. 10, 2022, which is incorporated by reference herein in its entirety.

### FIELD OF THE DISCLOSURE

The present disclosure relates generally to the field of aircraft propeller assemblies, and more specifically, to systems and methods for employing correlated magnets as a clutch system in a propeller hub assembly.

### BACKGROUND

Propeller hubs play a critical role in the operation of vehicles, such as aircraft, by serving as the central connecting point between the motor and the propeller blades. During normal operation, the propeller hub transfers power from the motor to the propeller blades to generate thrust, which enables the aircraft to fly. Although propeller hubs are designed to withstand significant forces and maintain structural integrity, they are not impervious to potential issues. For instance, when a propeller blade strikes a foreign object during operation (e.g., such as a bird, a piece of debris, a wall, etc.), substantial damage may be caused to the blade itself, the hub, or even the motor. This can result in imbalances, vibrations, and/or a loss of performance, which may compromise the aircraft's stability and potentially jeopardize the safety of the passengers and crew.

The present disclosure is accordingly directed to a propeller hub assembly that may employ a pair of correlated magnets to simulate the functionality of a clutch that may mechanically disengage the propeller hub from the motor upon a propeller impact event, thereby preventing further damage to the aircraft. The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for a propeller hub system that incorporates correlated magnets to mechanically disengage from a motor subsequent to a propeller strike event.

In one aspect, a hub system is disclosed. The hub system includes: a motor operably coupled to a first correlated magnet, wherein the first correlated magnet defines a first attachment surface having one or more first alignment configurations. The hub system may further include a propeller hub including one or more blades, wherein the propeller hub is operably coupled to a second correlated magnet, and wherein the second correlated magnet defines a second attachment surface having one or more second alignment configurations. In addition, the motor and the propeller hub may be removably coupled together via one or more of: a magnetic attraction force formed between the first attachment surface of the first correlated magnet and the second attachment surface of the second correlated magnet; and an engagement between the one or more first alignment configurations and the one or more second alignment configurations.

In another aspect, an aircraft is disclosed. The aircraft includes: a hub system, including: a motor operably coupled to a first correlated magnet, wherein the first correlated magnet defines a first attachment surface having at least one first alignment feature. The hub system may further include a propeller hub including one or more blades, wherein the propeller hub is operably coupled to a second correlated magnet, and wherein the second correlated magnet defines a second attachment surface having at least one second alignment feature configured to matingly engage with the at least one first alignment feature. In addition, the motor and propeller hub may be rotatably coupled together by the first and second correlated magnets

In yet another aspect, a method of coupling a propeller hub to a motor is disclosed. The method includes: operably coupling the motor to a first correlated magnet, wherein the first correlated magnet defines a first attachment surface having one or more first alignment configurations. The method may further include operably coupling the propeller hub to a second correlated magnet, wherein the propeller hub includes one or more blades and wherein the second correlated magnet defines a second attachment surface having one or more second alignment configurations. The method may further include rotatably coupling the motor to the propeller hub by aligning the first attachment surface of the first correlated magnet with the second attachment surface of the second correlated magnet, whereby the aligning causes a magnetic attractive force to form between the first attachment surface of the first correlated magnet and the second attachment surface of the second correlated magnet; and a mechanical engagement to be achieved between the one or more first geometric configurations and the one or more second geometric configurations.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate the disclosed embodiments, and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure. In the drawings:

FIG. 1 illustrates an exemplary hub assembly, according to one or more aspects of the present disclosure.

FIG. 2 illustrates an exemplary hub assembly, according to one or more aspects of the present disclosure.

FIG. 3 illustrates an exploded view of the exemplary hub assembly illustrated in FIG. 2, according to one or more aspects of the present disclosure.

FIG. 4A illustrates a top view of an exemplary correlated magnet containing a first magnetic pattern, according to one or more aspects of the present disclosure.

FIG. 4B illustrates a top view of an exemplary correlated magnet containing a second magnetic pattern, according to one or more aspects of the present disclosure.

FIG. 5A illustrates a top view of an exemplary correlated magnet containing a third magnetic pattern, according to one or more aspects of the present disclosure.

FIG. 5B illustrates a top view of an exemplary correlated magnet containing a fourth magnetic pattern, according to one or more aspects of the present disclosure.

FIG. 6 illustrates a magnetic attachment configuration between a first and second correlated magnet, according to one or more aspects of the present disclosure.

FIG. 7 illustrates an exemplary cross-section of a hub assembly taken at line A-A in FIG. 2, according to one or more aspects of the present disclosure.

FIG. 8A illustrates a perspective view of an exemplary correlated magnet containing protruding elements, according to one or more aspects of the present disclosure.

FIG. 8B illustrates a perspective view of an exemplary correlated magnet containing recessed portions, according to one or more aspects of the present disclosure.

FIG. 9 illustrates an exploded view of the exemplary hub assembly illustrated in FIG. 2, according to one or more aspects of the present disclosure.

FIG. 10A illustrates a first attachment configuration between two correlated magnets, according to one or more aspects of the present disclosure.

FIG. 10B illustrates a second attachment configuration between two correlated magnets, according to one or more aspects of the present disclosure.

### DESCRIPTION OF EXEMPLARY EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

Embodiments of the present disclosure may be incorporated into an aircraft. As used herein, “aircraft” may refer to an aerial, floating, soaring, hovering, airborne, aeronautical aircraft, airplane, plane, spacecraft, vessel, or virtually any other vehicle moving, or capable of moving, through air. Some non-limiting examples may include a helicopter, an airship, a hot air balloon, a vertical take-off craft (e.g., an electric vertical take-off and landing (eVTOL)), an unmanned aerial vehicle, or a drone.

Traditional propellers in aircraft typically have a fixed connection to the motor. This rigid connection means that any collision of the propeller blades with an external object may directly transmit the impact forces to the propeller and, consequently, to the motor. As a result, conventional propeller hub assemblies are prone to structural failure and may cause severe damage to the aircraft or other equipment. For example, when a propeller blade strikes a foreign object during operation, the impact may produce significant stress and strain on the propeller, potentially causing it to bend, break, or become misaligned. Due to the mechanical connections between the motor and the propeller, these stresses may also be transferred to the motor. In extreme cases, this can result in catastrophic failure, thereby compromising the safety of the aircraft and its occupants. These occurrences may necessitate costly repairs or replacement of damaged parts, which may lead to downtime and increased maintenance expenses. A need therefore exists for an improved propeller hub system that may mitigate the transfer of impact forces between the propeller and the motor, thereby minimizing the chances of further aircraft damage.

Accordingly, the present disclosure provides a novel propeller hub assembly (and connection mechanism) that leverages features of correlated magnets to prevent cascading damage to the motor and other aircraft components in response to a propeller impact event. More particularly, the novel assembly may contain two correlated magnets, one operatively coupled to the motor (e.g., by a first shaft) and another operatively coupled to a hub assembly (e.g., via a second shaft). During normal operation, the correlated magnets may be attached together by the magnetic attraction formed between the attachment surfaces of each magnet. More particularly, magnetic patterns (e.g., containing both north and south pole regions) may be present on the attachment surfaces of each magnet that, when aligned with one another, form a strong magnetic attraction between the two magnets and establish a magnetic coupling between the motor and the hub assembly. Upon a propeller impact event, the correlated magnet attached to the hub assembly may move relative to the correlated magnet attached to the motor, thereby causing the magnetic patterns to become misaligned with respect to one another. This misalignment event decouples the motor from the hub assembly, thereby preventing the stresses and forces generated by the propeller impact event from being transferred to the motor. Furthermore, the correlated magnets may be configured to dynamically realign with one another, after the propeller impact event, to cause the propeller blades to spin, thereby preserving aircraft flight capabilities.

In another aspect, in addition to the magnetic attraction formed between the two correlated magnets, the magnets may further be attached together by the union (and corresponding frictional engagement) of protruding elements on the attachment surface of one correlated magnet with the recessed portions on the attachment surface of the other correlated magnet. Similarly to the foregoing, upon a propeller impact event, the correlated magnet attached to the hub assembly may move relative to the correlated magnet attached to the motor, thereby causing the protruding elements to be disengaged from the recessed portions and effectively limiting the damage that may be caused to the motor. The protruding elements may be configured to subsequently reengage with the recessed portions, thereby re-establishing rotational movement to the propeller blades.

The subject matter of the present disclosure will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments,” or “in one aspect” or “in some aspects” as used herein does not necessarily refer to the same embodiment or aspect, and the phrase “in another embodiment” or “in another aspect” as used herein does not necessarily refer to a different embodiment or aspect. It is intended, for example, that claimed subject matter include combinations of exemplary embodiments in whole or in part.

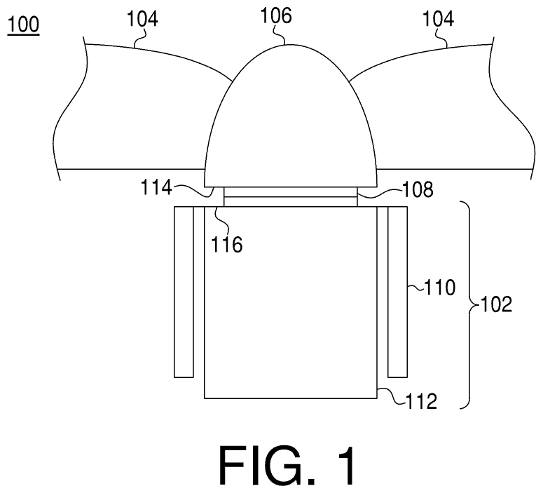

Referring now to FIG. 1, an exemplary hub assembly 100 is illustrated. The exemplary hub assembly 100 may include motor 102, one or more propeller blades 104, and hub 106. Motor 102 may be an electric motor that is mechanically connected to hub 106 to drive one or more blades 104 (e.g., to produce thrust). In some embodiments, motor 102 may comprise outrunner portion 110 and static portion 112. Outrunner portion 110 may include permanent magnets whereas static portion 112 may include coiled electromagnets. Outrunner portion 110 may be configured such that the active rotational inertia of the motor is reduced. In an aspect, hub 106 may be configured to support virtually any number of propeller blades (e.g., two propellers, three propellers, four propellers, etc.). In an aspect, each of propeller blades 104 may be in the shape of an airfoil that contains camber and twist along the length of the blade, which may therefore be enabled to generate lift and thrust.

Exemplary hub assembly 100 may include correlated magnet pair 108. Correlated, or “programmed”, magnets are magnetic structures that incorporate correlated patterns of magnets with alternating polarity, which are designed to achieve a desired behavior and to deliver stronger local force. Specifically, the magnetic face of the correlated magnet may contain a variety of multipole structures containing multiple magnetic elements of varying size, location, orientation, and saturation. By varying the magnetic fields and strengths, different mechanical behaviors may be controlled. For example, correlated magnets may be configured to attract or repel with a prescribed force and engagement distance and/or to attract or repel at a certain spatial orientation. In certain instances, correlated magnets may even be programmed to attract and repel at the same time. Collectively, compared to conventional magnets, correlated magnets provide a much stronger holding force to the target and stronger shear resistance.

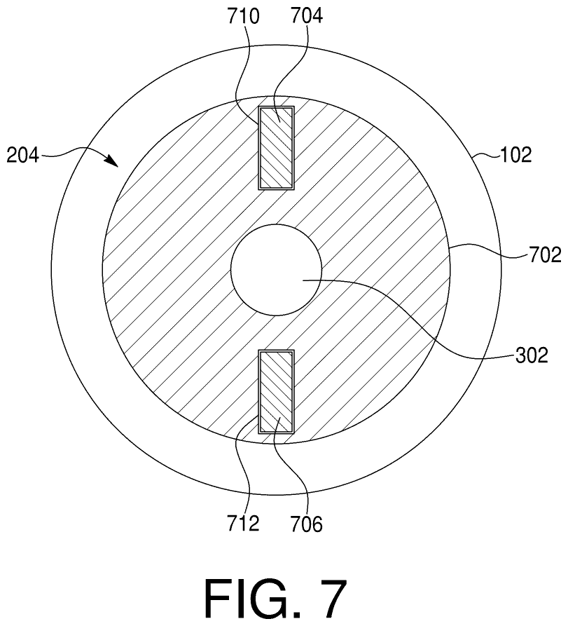

The correlated magnets described herein may be made from material such as ferrites, rare-earth materials (e.g., Neodymium magnet, Samarium-cobalt magnet, or other similar materials), ceramics, electromagnets, or any other magnetic material known to those skilled in the art. In an aspect, both correlated magnets may be composed of the same material or, alternatively, one correlated magnet may be composed of a material different than the other. In an aspect, the shape and/or dimensions of the correlated magnets, along with the shape and/or dimensions of the recessed portions and protruding elements (as further described herein and as illustrated in FIGS. 7-10(A-B), may be formed by leveraging one or more manufacturing and machining processes known in the art. For example, powder metallurgy may be utilized as the metal-forming process to construct a magnetic block that may thereafter be sliced, ground, smoothed, and shaped using various types of machining tools.

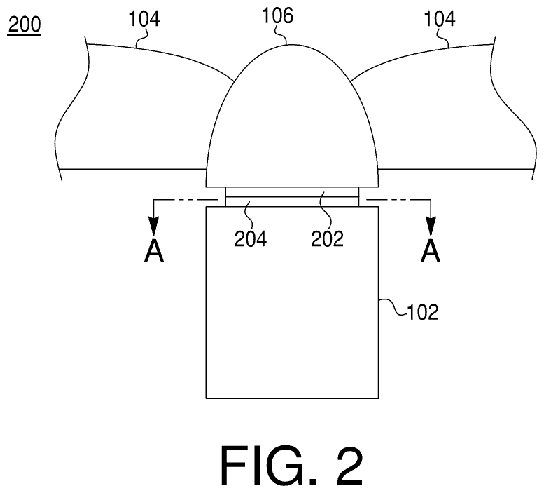

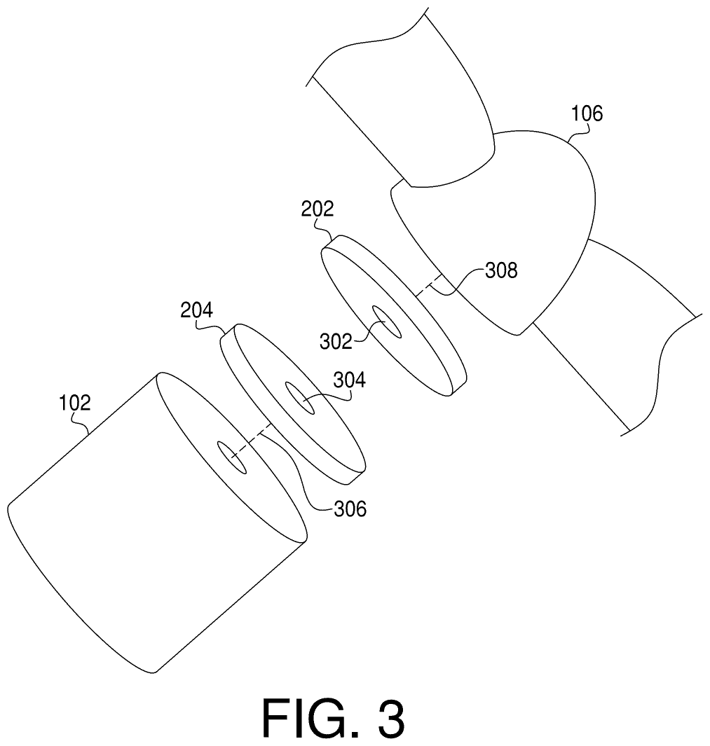

Referring now to FIG. 2, an exemplary hub assembly 200 is illustrated. Exemplary hub assembly 200 may contain correlated magnets 202, 204 (each of which constitutes one half of correlated magnet pair 108 illustrated in FIG. 1). Collectively, correlated magnets 202, 204 may be configured to attach hub 106 to motor 102. More particularly, motor 102 may be connected to correlated magnet 204 via a first shaft (e.g., as depicted in FIG. 3 and as further described herein) and hub 106 may be connected to correlated magnet 202 via a second shaft (e.g., as depicted in FIG. 3 and as further described herein). Ultimately, hub 106 may be secured against motor 102 via the magnetic attraction formed between correlated magnets 202, 204. For example, in an aspect, an entirety of each attachment surface of correlated magnets 202, 204 (e.g., the surface of each magnet that interacts with the other) may be designated to a single magnetic pole. For instance, the attachment surface of correlated magnet 202 may be configured with a pole (e.g., a north pole) that is magnetically attracted to an opposite pole (e.g., a south pole) of the attachment surface of correlated magnet 204. Alternatively, in another aspect, each attachment surface of correlated magnets 202, 204 may be configured to contain multiple north and south pole regions that may be arranged in a particular pattern that, when geometrically aligned based on pole orientations, facilitate a strong magnetic coupling between the magnets, thereby establishing a magnetic coupling between hub 106 and motor 102.

Although illustrated in the FIGS. 3-10(A-B) as circular, such a designation is not limiting and each of correlated magnets 202, 204 may be configured to be virtually any other shape (e.g., a square, a circle, a triangle, etc.). In one aspect, both of correlated magnets 202, 204 may be identically shaped (e.g., both magnets may be circles). In another aspect, correlated magnet 202 may be differently-shaped than correlated magnet 204 (e.g., correlated magnet 202 may be a circle and correlated magnet 204 may be a square). Additionally or alternatively, the size and/or dimension of each of the magnets may be identical or different. For example, when correlated magnets 202, 204 are both circle shaped, they may each have identical dimensions (e.g., the diameter and thickness of magnets 202, 204 may be the same). In another example, correlated magnets 202, 204 may each have an identical diameter, but one of the magnets may be thicker than the other. In yet another example, one of correlated magnets 202, 204 may have a larger diameter and thickness than the other. In yet another example, one of correlated magnets 202, 204 may have a larger diameter, but a thinner thickness, than the other. Other dimensional configurations for the correlated magnets are possible but are not explicitly described herein. In certain configurations, the size, shape, and/or dimensions of the correlated magnets may be dictated at least partially by the size, shape, dimensions, and/or location of the motor and/or the propeller assembly.

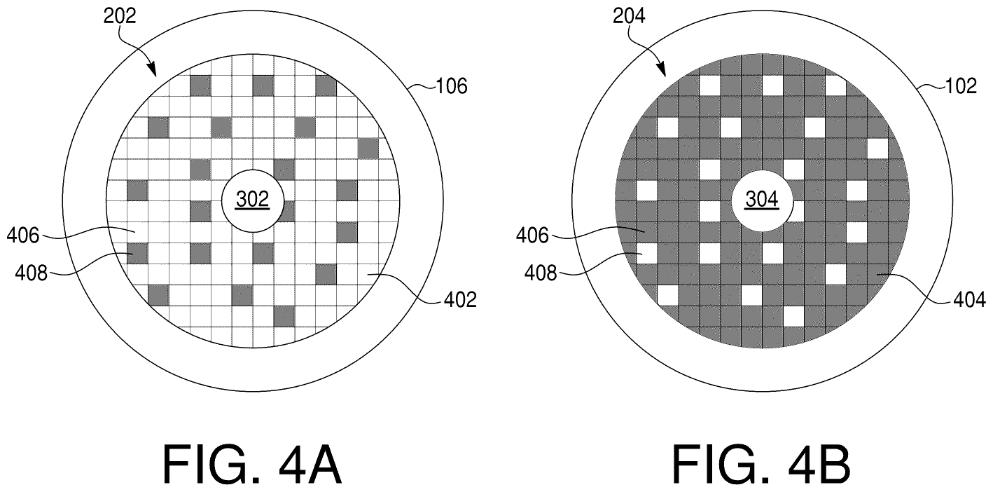

Referring now to FIG. 3, an exploded view of the exemplary hub assembly depicted in FIG. 2 is provided. As illustrated, correlated magnet 204 may be connected to motor 102 by a first shaft (e.g., an input shaft such as a crankshaft), represented by dashes 306, which may extend from motor 102 through hole 304 and may terminate at attachment surface 404 (shown in FIG. 4B). Correlated magnet 202 may be connected to hub 106 by a second shaft (e.g., an output shaft), represented by dashes 306, which extends from hub 106 through hole 308 and terminates at attachment surface 402 (shown in FIG. 4A). Attachment surfaces 402, 404 of correlated magnets 202, 204 may be positioned opposite one another in the hub assembly. When correlated magnets 202, 204 are in a geometrically aligned state, e.g., when all pole regions (e.g., regions designated with either a north or south pole orientation) of a first magnetic pattern of correlated magnet 202 are aligned relative to all pole regions of a second magnetic pattern of correlated magnet 204, a strong magnetic attraction may be formed between correlated magnets 202, 204 and torque from motor 102 may be transmitted to hub 106 via the attached magnet assembly 108. Specifically, during operation, motor 102 may cause first shaft 306 and correlated magnet 204 to rotate in Direction X. Correlated magnet 202 and second shaft 308 may also be caused to rotate in Direction X when attached to correlated magnet 204, thereby transferring torque to hub 106 and facilitating rotation of blades 104.

In response to a propeller impact event, correlated magnet 202 may be configured to become decoupled from correlated magnet 204. More particularly, when a force threshold is exceeded, the first magnetic pattern of correlated magnet 202 may be forced to become unaligned relative to the second magnetic pattern of correlated magnet 204 so that one or more pole regions between magnets 202, 204 do not share a magnetic attraction. When misaligned, correlated magnet 204 may continue to rotate in Direction X whereas correlated magnet 202 may be caused: to no longer rotate, rotate in Direction X at a lower speed, or rotate in Direction Y opposite Direction X. This decoupling action may limit the damage that may be caused to correlated magnet 204, first shaft 306, and/or motor 102 from the stresses and forces of the propeller impact event.

Correlated magnets 202, 204 may again return to a coupled state after the propeller impact event without additional manual intervention. More particularly, during magnetic misalignment, one or more pole regions of the first magnetic pattern may still share a magnetic attraction to one or more corresponding pole regions of the second magnetic pattern. Although not as strong as the magnetic attraction that may be formed when the first and second magnetic patterns are fully aligned, the “partial” magnetic attraction between correlated magnets 202, 204 in the misaligned state may cause correlated magnets 202, 204 to maintain spatial alignment relative to one another (e.g., such that attachment surface 402 may be maintained opposite from attachment surface 404 at a predetermined distance). Continued rotation of correlated magnet 204 relative to correlated magnet 202 may eventually cause the first and second magnetic patterns to become aligned again (e.g., after half a revolution, a full revolution, etc.). When such alignment is achieved, the strong magnetic attraction between correlated magnets 202, 204 may be re-instituted and propeller blades 104 may again be caused to rotate, thereby maintaining an aircraft's ability to generate thrust and fly.

Referring collectively to FIGS. 4A-4B, top views of correlated magnets 202, 204 are provided in which a first and second magnetic pattern are displayed, respectively. With respect to FIG. 4A, correlated magnet 202 is illustrated as having a first magnetic pattern on attachment surface 402. The first magnetic pattern may contain a plurality of north-oriented pole regions (e.g., represented by the grey-shaded regions) and a plurality of south-oriented pole regions (e.g., represented by the white regions) arranged in a “scattered” design pattern. With respect to FIG. 4B, a second magnetic pattern is presented on attachment surface 404. In an aspect, the second magnetic pattern may be designed to contain directly opposite pole regions as the first magnetic pattern. More particularly, when the second magnetic pattern is overlaid against and fully aligned with the first magnetic pattern, each north-oriented and south-oriented pole region of the first magnetic pattern would be magnetically attracted to each corresponding south-oriented and north-oriented pole region of the second magnetic pattern. For example, spatial regions 406, 408 of attachment surface 402 may be south-oriented and north-oriented respectively. Conversely, spatial regions 406, 408 of attachment surface 404 may be north-oriented and south-oriented respectively (e.g., directly opposite to the magnetic pattern design in attachment surface 402). Even when not fully aligned, some north-oriented pole regions of attachment surface 402 may still be magnetically attracted to some south-oriented pole regions of attachment surface 404 that may be located directly opposite the north-oriented pole regions. These “misaligned attraction events” may collectively generate a holding force that keeps correlated magnets 202, 204 physically aligned until magnetic realignment of the first and second magnetic pattern is achieved.

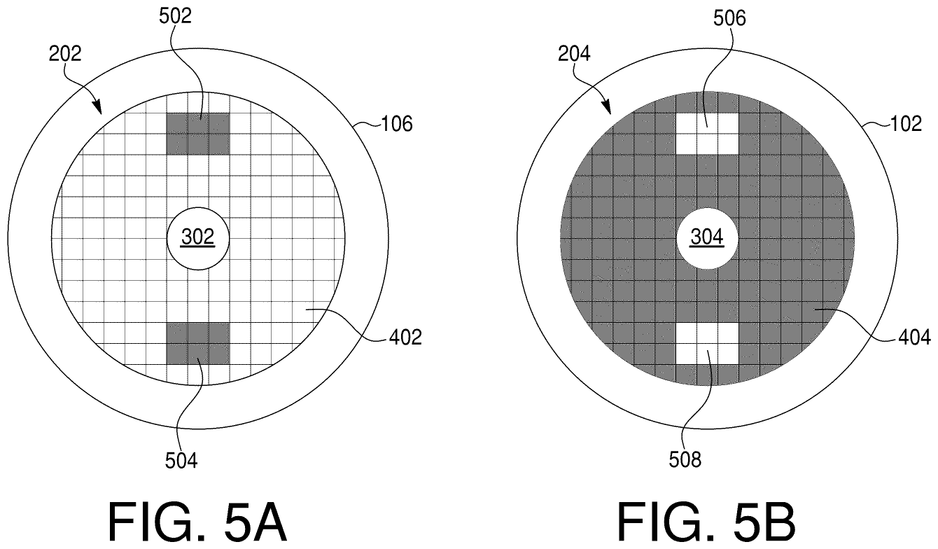

Referring collectively to FIGS. 5A-5B, top views of correlated magnets 202, 204 are provided in which a third and fourth exemplary magnetic pattern are displayed, respectively. Opposite to the “scattered” magnetic patterns illustrated in FIGS. 4A-4B, the magnet patterns illustrated in FIGS. 5A and 5B contain more clearly delineated regions, or groups, of north or south magnetic polarity. With respect to FIG. 5A, correlated magnet 202 is illustrated as having a third magnetic pattern in which two distinct rectangular portions 502, 504, each composed of a plurality of square-shaped, north-oriented pole regions, are provided. The two distinct rectangular portions 502, 504, may be configured to be magnetically attracted to rectangular portions 506, 508 of correlated magnet 204 in FIG. 5B, each containing a plurality of square-shaped, south-oriented pole regions. The remainder of attachment surface 402, outside of regions 502, 504, may contain south-oriented pole regions and the remainder of attachment surface 404, outside of regions 506, 508, may contain north-oriented pole regions. Similar to the correlated magnets illustrated in FIGS. 4A-4B, when the third and fourth magnetic patterns are fully aligned, e.g., when regions 502, 504 of correlated magnet 202 are positioned opposite of regions 506, 508 of correlated magnet 204, a strong magnetic attraction may be formed between correlated magnets 202, 204.

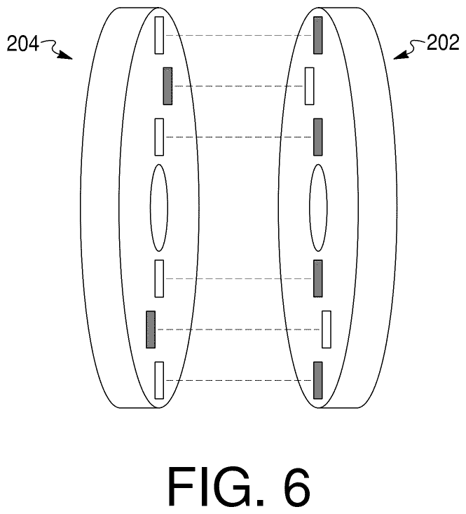

Referring now to FIG. 6, a side view of correlated magnets 202, 204 in a fully aligned state is provided. The magnetic patterns of correlated magnets 202, 204 in FIG. 6 are intentionally simplified to illustrate the magnetic attraction that may be formed between the two magnets. As seen, each of the pole regions in correlated magnet 202 is aligned with opposite pole regions of correlated magnet 204. In this state, a strong magnetic connection may exist between magnets 202, 204, thereby magnetically coupling motor 102 to hub assembly 106. When correlated magnet 202 moves relative to correlated magnet 204 (e.g., when correlated magnet 202 is caused to rotate in an opposite direction than correlated magnet 204 in response to a propeller strike event) the alignment between magnets 202, 204 may be broken so that not all of the pole regions in correlated magnet 202 align with opposite pole regions of correlated magnet 204.

It is important to note that the characteristics (e.g., pattern layout, pole region size, pole region shape, etc.) of the magnetic patterns illustrated in FIGS. 4(A-B)-6, are not limiting and that virtually any other type of magnetic pattern and/or pole region geometry is contemplated herein. For example, magnetic patterns may contain triangular-shaped pole regions, circular-shaped pole regions, spiral-shaped pole regions, asymmetrically-shaped pole regions, any combination of the foregoing, and the like. Furthermore, in one aspect, a first magnetic pattern may contain an equal or different number of north-oriented pole regions and south-oriented pole regions. Additionally or alternatively, in another aspect, the size of some or all north-oriented pole regions in a magnetic pattern may be the same or different as the size of some or all south-oriented pole regions in a corresponding magnetic pattern. Additionally or alternatively, in another aspect, the shape of all pole regions in both magnetic patterns may be the same. Alternatively, in another aspect, the shapes of the north-oriented and south-oriented pole regions in a single magnetic pattern may vary.

In an aspect, the magnetic patterns may be designed to contain one or more alignment configurations. For instance, in an aspect, only one alignment configuration may exist between a first and second magnetic pattern such that the first magnetic pattern must be aligned relative to the second magnetic pattern a single, specific way for a strong magnetic attraction to be formed between the two correlated magnets. For example, in this aspect, supposing one correlated magnet stayed still, a full revolution of the other correlated magnet may be required to realign the first and second magnetic patterns. Alternatively, in another aspect, two or more alignment configurations may exist between a first and second magnetic pattern such that the first magnetic pattern may be aligned relative to the second magnetic pattern in at least two different ways for a strong magnetic attraction to be formed between the two correlated magnets. For example, in this aspect, supposing one correlated magnet stayed still and the other rotated, only a partial revolution of the rotating magnet may be required to realign the first and second magnetic patterns.

FIGS. 7-10(A-B) illustrate aspects of the disclosure in which the correlated magnets additionally contain geometric configurations that are configured to mechanically engage and disengage to provide additional support for the hub assembly. The geometric configurations illustrated in FIGS. 7-10(A-B) may be provided on attachment surfaces of the correlated magnets in addition to the magnetic patterns described above. Stated differently, two correlated magnets may be engaged together by both, a magnetic attraction force facilitated by full or partial alignment of a first magnetic pattern with a second magnetic pattern and a mechanical engagement between the geometric configurations of each magnet, the latter helping to further secure the magnets together.

Referring now to FIG. 7, a sectional view taken along section A-A, as depicted in FIG. 2, is provided. A surface of correlated magnet 204 is shown that contains hole 302 and recessed portions 710, 712. Hole 302 may be configured to support a first shaft (e.g., an input shaft) that may be operatively coupled to motor 102, which may effectively enable rotation of correlated magnet 204, as further described herein. Recessed portions 710, 712, or “cavities,” may correspond to areas of correlated magnet 204 that have been recessed to a predetermined depth. These areas may be configured to support corresponding protruding elements 704, 706 of correlated magnet 202 (not illustrated). Collectively, the recessed portions and the protruding elements may be referred to as “geometric configurations.” Additional details regarding the structure of correlated magnets 202, 204 containing the geometric configurations, and their relationship with one another during operation of the aircraft and during a propeller impact event, is further described herein.

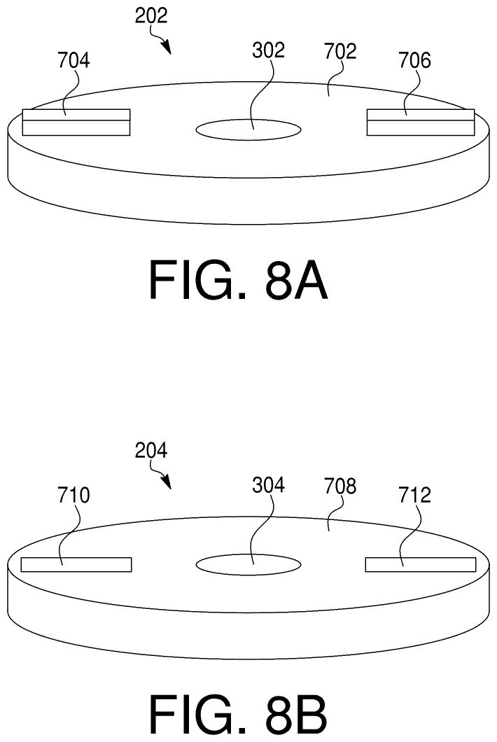

Referring collectively to FIGS. 8A-8B, perspective views of correlated magnets 202, 204 are provided. With respect to FIG. 8A, correlated magnet 202 is illustrated as having protruding elements 704, 706 that are positioned on opposite ends of attachment surface 702. Hole 302 may be positioned at a midpoint between protruding elements 704, 706 and may be configured to support an output shaft (not illustrated) that may be operatively coupled to hub 106. With respect to FIG. 8B, correlated magnet 204 is illustrated as having recessed portions 710, 712 that are positioned on opposite ends of attachment surface 708. Hole 304 may be positioned at a midpoint between recessed portions 710, 712 and may be configured to support a first shaft (not illustrated) that may be operatively coupled to motor 106. In an attached state, each of protruding elements 704, 706 of correlated magnet 202 may be positioned within corresponding recessed portions 710, 712 of correlated magnet 204. For example, protruding element 704 may be positioned within recessed portion 710 and protruding element 706 may be positioned within recessed portion 712.

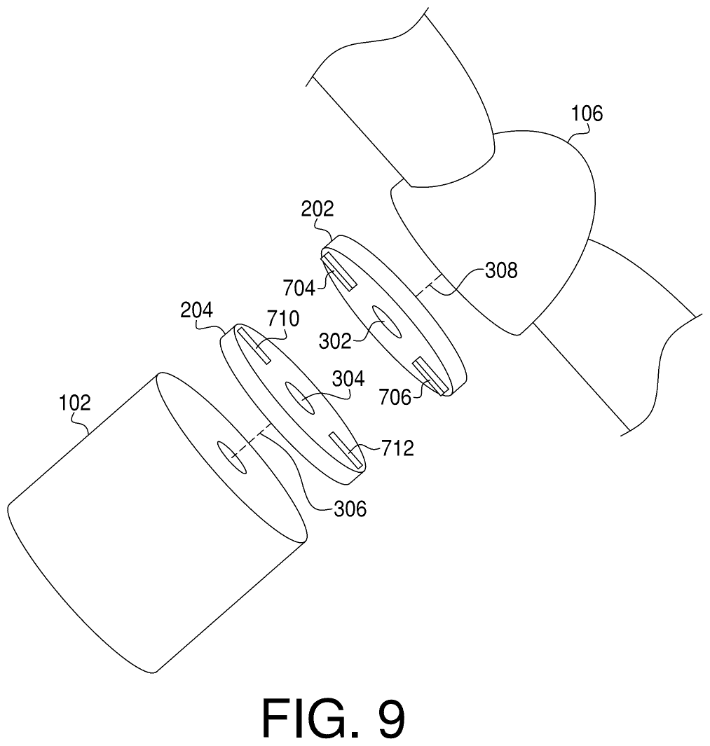

Referring now to FIG. 9, an exploded view of the exemplary hub assembly depicted in FIG. 2 is provided. As illustrated, correlated magnet 204 may be connected to motor 102 by a first shaft (e.g., an input shaft such as a crankshaft), represented by dashes 306, which may extend from motor 102 through hole 316 and may terminate at attachment surface 708 (shown in FIG. 8B). Correlated magnet 202 may be connected to hub 106 by a second shaft (e.g., an output shaft), represented by dashes 308, which extends from hub 106 through hole 308 and terminates at attachment surface 302 (shown in FIG. 8A). When correlated magnets 202, 204 are in an attached state, e.g., when protruding elements 704, 706 of correlated magnet 202 are positioned within recessed portions 710, 712 of correlated magnet 204, torque from motor 102 may be transmitted to hub 106 via the attached magnet assembly 108. Specifically, during operation, motor 102 may cause first shaft 306 and correlated magnet 204 to rotate in Direction X. Correlated magnet 202 and second shaft 308 may also be caused to rotate in Direction X when attached to correlated magnet 204, thereby transferring torque to hub 106 and facilitating rotation of the blades 104.

In response to a propeller impact event, correlated magnet 202 may be configured to become decoupled from correlated magnet 204. More particularly, when a force threshold is exceeded, protruding elements 704, 706 may be forced out of corresponding recessed portions 710, 712. When disconnected, correlated magnet 204 may continue to rotate in Direction X whereas correlated magnet 202 may be caused: to no longer rotate, rotate in Direction X at a lower speed, or rotate in Direction Y opposite Direction X. This decoupling action may limit the damage that may be caused to correlated magnet 204, first shaft 306, and/or motor 102 from the stresses and forces of the propeller impact event.

Correlated magnets 202, 204 may again return to an attached state after the propeller impact event without additional manual intervention. More particularly, recessed portions 710, 712 of independently rotating correlated magnet 204 may eventually realign with protruding elements 704, 706 of correlated magnet 202 (e.g., after half a revolution, a full revolution, etc.). When such alignment is achieved, protruding elements 704, 706 may dynamically reinsert into recessed portions 710, 712 (e.g., protruding element 704 may be repositioned within recessed portion 712 and protruding element 706 may be repositioned within recessed portion 710) and the propeller blades 104 may again be caused to rotate, thereby maintaining an aircraft's ability to generate thrust and fly.

Although illustrated in FIGS. 7-10(A-B) as rectangular, such a designation is not limiting and both recessed portions and protruding elements of correlated magnets 202, 204 may be manufactured to be virtually any shape, e.g., a square, a circle, a triangle, etc. In one aspect, the recessed portions and the protruding elements may be the same shape (e.g., both may be rectangle-shaped, as illustrated in FIGS. 7-10(A-B). In another aspect, the recessed portions and the protruding elements may be differently-shaped (e.g., the recessed portions may be square-shaped and the protruding elements may be circle-shaped). In yet another aspect, in configurations containing multiple recessed portions and/or multiple protruding elements, some recessed portions and/or some protruding elements may be differently-shaped than others. For example, correlated magnet 204 may contain two recessed portions, where one recessed portion is rectangle-shaped and the other recessed portion is circle-shaped. Similarly, correlated magnet 202 may contain two protruding elements, where one protruding element is rectangle-shaped and the other protruding element is circle-shaped. In such a configuration, the rectangular protruding element of correlated magnet 202 may be configured to enter the corresponding rectangular recessed portion of correlated magnet 204 and the circular protruding element of correlated magnet 202 may be configured to enter the corresponding circular recessed portion of correlated magnet 204. In some aspects, multiple protruding elements may exist that, collectively, may be designed to fit into a single recessed portion. For example, given a rectangle-shaped recessed portion on a first correlated magnet, a series of smaller square-shaped protrusions, arranged in a line, may be present on the second correlated magnet that may each fit into the recessed portion when the first and second correlated magnets are aligned. Other combinations of shapes for the recessed portions and/or the protruding elements are possible but are not explicitly described herein.

In an aspect, all recessed portions may be recessed to an identical depth (e.g., approximately 2 mm, 4 mm, 6 mm, etc.). For instance, given correlated magnet 204, recessed portions 710, 712 may each be recessed to a depth of approximately 4 mm. In some aspects, recessed portions 710, 712 may both be holes that extend through an entirety of the thickness of correlated magnet 204 (e.g., from attachment surface 708 to an opposite surface (not illustrated)). In another aspect, the depth of different recessed portions may vary. For example, recessed portion 710 may be manufactured to be 4 mm deep and recessed portion 712 may be manufactured to be approximately 6 mm deep. In a similar vein, all protruding elements may be identically-sized with respect to their height. For instance, given correlated magnet 202, protruding elements 704, 706 may each have a height dimension of approximately 4 mm. In another aspect, the height of different protruding elements may vary. For example, protruding element 704 may be manufactured to have a height of 4 mm and protruding element 706 may be manufactured to have a height of approximately 6 mm. Other combinations of heights of both of the recessed portions and protruding elements are possible but are not explicitly described herein. In any aspect, the height of any of the protruding elements may not exceed the depth of any corresponding recessed portion.

Although illustrated in FIGS. 7-10(A-B) as located directly opposite one another, such a designation is not limiting and the arrangement of the recessed portions around the attachment surface 708 of correlated magnet 204 may vary. For instance, in a configuration where correlated magnet 202 has only one protruding element, a first recessed portion of correlated magnet 204 may be positioned at the 12'o clock position and a second recessed portion may be positioned at the 3'o clock position. In an aspect, some or all of the recessed portions may be positioned at or near an edge of correlated magnet 204, as illustrated in FIGS. 7-10(A-B). Alternatively, in another aspect, some or all of the recessed portions may be positioned at locations on attachment surface 708 away from the edge (e.g., closer to hole 304). In yet another aspect, in a configuration containing multiple recessed portions, some recessed portions may be positioned at or near the edge of attachment surface 708 whereas other recessed portions may be positioned near hole 304. Similarly to the foregoing, in an aspect, some or all of the protruding elements may be positioned at or near an edge of correlated magnet 202, as illustrated in FIGS. 7-10(A-B). Alternatively, in another aspect, some or all of the protruding elements may be positioned at locations on attachment surface 702 away from the edge (e.g., closer to hole 302). In yet another aspect, in a configuration containing multiple protruding elements, some protruding elements may be positioned at or near the edge of attachment surface 702 whereas other protruding elements may be positioned nearer to hole 302. Other combinations of placement locations for both the recessed portions and protruding elements are possible but are not explicitly described herein.

Although illustrated in FIGS. 7-9 as containing two recessed portions 710, 712 and two protruding portions 704, 706, such designations are not limiting and attachment surface 708 may contain more or less recessed portions and attachment surface 702 may contain more or less protruding elements. For example, in one aspect, attachment surface 708 may be manufactured to contain two recessed portions and attachment surface 702 may be manufactured to contain only a single protruding element. In such a configuration, the single protruding element may be configured to transition from the first recessed portion to the second recessed portion upon a propeller impact event. In another aspect, attachment surface 708 may be manufactured to contain a single recessed portion and attachment surface 702 may be manufactured to contain a single protruding element. In such a configuration, the single protruding element may be configured to be forced out of the single recessed portion upon a propeller impact event and eventually reenter the single recessed portion. In yet another aspect, attachment surface 708 may be manufactured to contain four recessed portions and attachment surface 702 may be manufactured to contain four protruding elements. In such a configuration, each of the four protruding elements may be configured to be forced out of their corresponding recessed portions and re-enter an adjacent recessed portion. Other configurations containing a varying number of recessed portions and protruding elements are possible but are not explicitly described herein. In any aspect, attachment surface 702 may not contain more protruding elements than attachment surface 708 contains recessed portions.

Although correlated magnet 202 is illustrated as containing protruding element 704, 706 and correlated magnet 204 is illustrated as containing recessed portions 710, 712, such a designation is not limiting and the opposite may be true in various configuration (e.g., correlated magnet 202 may contain the recessed portions and correlated magnet 204 may contain the protruding elements).

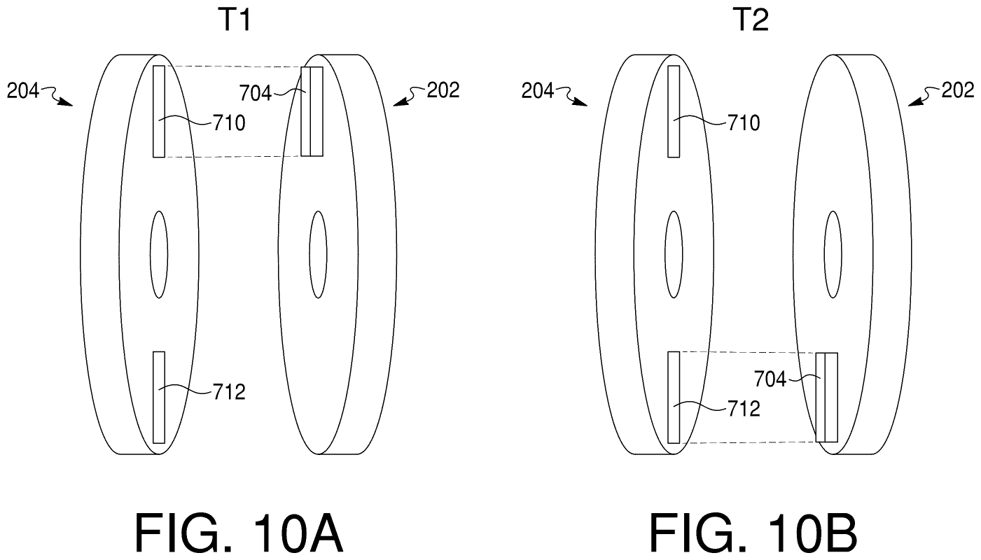

Referring now to FIGS. 10A-10B, a non-limiting example of the movement of correlated magnet 202 with respect to correlated magnet 204 in response to a propeller impact event is illustrated. In this implementation, correlated magnet 204 may be operatively coupled to motor 102 (not illustrated) and correlated magnet 202 may be operatively coupled to hub 106 (not illustrated). Correlated magnet 204 may contain two recessed portions 710, 712 and correlated magnet 202 may contain only one protruding element 704. During normal operation, as designated by time T1 in FIG. 10A, protruding element 704 of correlated magnet 202 may be positioned inside recessed portion 710 of correlated magnet 204. The attachment of correlated magnets 202, 204 may cause correlated magnet 202 to rotate in conjunction with correlated magnet 204 in Direction X, which may effectively cause the propeller blades 104 (not illustrated) to spin.

Further to the foregoing, if a propeller blade 104 collides with an object, correlated magnet 202 may experience an impact event in which an external force (e.g., a stopping force applied to the propeller blade 104 from the propeller strike) may cause stoppage and/or counter-rotation (e.g., in direction Y) of correlated magnet 202 with respect to the rotational direction X of correlated magnet 204. If this stoppage force exceeds a predetermined threshold, protruding element 704 may be dislodged from recessed portion 710. Correlated magnet 202 may continue to independently rotate in direction X until protruding element 304 is aligned with and repositioned within recessed portion 712, e.g., at time T2 in FIG. 10B. A holding force, caused by the magnetic attraction between correlated magnets 202, 204, may hold correlated magnets 202, 204 together during the repositioning event. This force-initiated decoupling of correlated magnets 202, 204 may thereby limit and/or prevent damage from being caused to the motor (e.g., by preventing correlated magnet 204 from abruptly stopping and/or counter-rotating). Furthermore, the successive recoupling of correlated magnets 202, 204 may preserve propeller functionality and/or flight capabilities of the aircraft if the impact event occurs in flight.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention. The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A hub system comprising:
a motor operably coupled to a first correlated magnet, wherein the first correlated magnet defines a first attachment surface having one or more first alignment configurations; and
a propeller hub including one or more blades, wherein the propeller hub is operably coupled to a second correlated magnet, and wherein the second correlated magnet defines a second attachment surface having one or more second alignment configurations;
wherein the motor and the propeller hub are removably coupled together via one or more of:
a magnetic attraction force formed between the first attachment surface of the first correlated magnet and the second attachment surface of the second correlated magnet; and
an engagement between the one or more first alignment configurations and the one or more second alignment configurations.

2. The hub system of claim 1, wherein the one or more first alignment configurations include a first magnetic pattern and wherein the one or more second alignment configurations include a second magnetic pattern.

3. The hub system of claim 2, wherein the engagement is a magnetic engagement defined by a first set of alternating north and south pole regions in the first magnetic pattern being magnetically attracted to a second set of alternating north and south pole regions in the second magnetic pattern.

4. The hub system of claim 1, wherein the one or more first alignment configurations correspond to one or more first geometric configurations and wherein the one or more second alignment configurations correspond to one or more second geometric configurations.

5. The hub system of claim 4, wherein the one or more first geometric configurations or the one or more second geometric configurations are cavities.

6. The hub system of claim 4, wherein the one or more first geometric configurations or the one or more second geometric configurations are protrusions.

7. The hub system of claim 1, wherein the engagement between the one or more first alignment configurations and the one or more second alignment configurations is configured to be broken in response to an external force applied to the one or more blades of the propeller hub.

8. The hub system of claim 7, wherein, when the engagement is broken, the first correlated magnet is configured to rotate relative to the second correlated magnet.

9. The hub system of claim 8, wherein rotation of the first correlated magnet relative to the second correlated magnet causes at least one of the one or more first alignment configurations to mate with at least one of the one or more second alignment configurations.

10. An aircraft, comprising:
a hub system, including:
a motor operably coupled to a first correlated magnet, wherein the first correlated magnet defines a first attachment surface having at least one first alignment feature; and
a propeller hub including one or more blades, wherein the propeller hub is operably coupled to a second correlated magnet, and wherein the second correlated magnet defines a second attachment surface having at least one second alignment feature configured to matingly engage with the at least one first alignment feature;
wherein the motor and propeller hub are rotatably coupled together by the first and second correlated magnets.

11. The aircraft of claim 10, wherein the at least one first alignment feature includes a first magnetic pattern and wherein the at least one second alignment feature includes a second magnetic pattern.

12. The aircraft of claim 11, wherein the first magnetic pattern includes a first set of alternating north and south pole regions and wherein the second magnetic pattern includes a second set of alternating north and south pole regions.

13. The aircraft of claim 10, wherein the at least one first alignment feature includes a first plurality of geometric features arranged on the first attachment surface and wherein the at least one second alignment feature includes a second plurality of geometric features arranged on the second attachment surface.

14. The aircraft of claim 13, wherein the first plurality of geometric features are recesses and wherein the second plurality of geometric features are protrusions.

15. The aircraft of claim 10, wherein the aircraft is an electric vertical take-off and landing vehicle.

16. The aircraft of claim 10, wherein, when the motor and propeller hub are rotatably coupled together by the first and second correlated magnets, the at least one first alignment feature is mated with the at least one second alignment feature.

17. The aircraft of claim 16, wherein the at least one first alignment feature is configured to be unmated from the at least one second alignment feature when a force is applied to a blade of the propeller.

18. The aircraft of claim 17, wherein the first correlated magnet is configured to rotate relative to the second configured magnet.

19. A method of coupling a propeller hub to a motor, comprising:
operably coupling the motor to a first correlated magnet, wherein the first correlated magnet defines a first attachment surface having one or more first alignment configurations;
operably coupling the propeller hub to a second correlated magnet, wherein the propeller hub includes one or more blades and wherein the second correlated magnet defines a second attachment surface having one or more second alignment configurations; and
rotatably coupling the motor to the propeller hub by aligning the first attachment surface of the first correlated magnet with the second attachment surface of the second correlated magnet, whereby the aligning causes:
a magnetic attractive force to form between the first attachment surface of the first correlated magnet and the second attachment surface of the second correlated magnet; and
an engagement to be achieved between the one or more first alignment configurations and the one or more second alignment configurations.

20. The method of claim 19, wherein the engagement between the one or more first alignment configurations and the one or more second alignment configurations is configured to be altered in response to an external force to the one or more blades of the propeller hub.
